(19) United States
(12) Patent Application Publication
(10) Pub. No.: US 2012/0328851 A1
(43) Pub. Date: Dec. 27, 2012

(54) MASK UNIT

(76) Inventor: Taek-Kyo Kang, Yongin-city (KR)

(21) Appl. No.: 13/425,376

(22) Filed: Mar. 20, 2012

(30) Foreign Application Priority Data
Jun. 21, 2011 (KR) 10-2011-0060248

(51) Int. Cl. B32B 3/00

(52) U.S. Cl. 428/195.1

(57) ABSTRACT

A mask unit includes: a unit mask having a plurality of patterned areas arranged along a length direction of the unit mask and a dummy area disposed between two of the plurality of patterned areas; a mask frame coupled to lateral ends of the unit mask in the length direction of the unit mask to apply a tension force to the unit mask along the length direction of the unit mask; and a cross-tension member coupled to the dummy area of the unit mask and extending in a direction crossing the length direction of the unit mask to apply a tension force to the unit mask in the direction crossing the length direction of the unit mask.

### CROSS-REFERENCE TO RELATED APPLICATION

This application claims priority to and the benefit of Korean Patent Application No. 10-2011-0060248 filed in the Korean Intellectual Property Office on Jun. 21, 2011, the entire content of which is incorporated herein by reference.

### BACKGROUND

1. Field

Aspects of embodiments of the present invention generally relate to a mask unit.

2. Description of Related Art

Recently, flat panel displays, such as an organic light emitting diode (OLED) display or a liquid crystal display (LCD), have been in the spotlight.

A flat panel display can be manufactured through a plurality of thin film processes. In addition, various masks are used in most of the thin film processes. Among the various masks, a mask unit of which a plurality of unit masks are fixed to a frame is widely used. The unit masks of the mask unit are fixed to the frame for application of a tension force in lateral directions.

However, the unit masks are tensed by being pulled at lateral ends thereof, so that the unit mask that is tensed and fixed to the frame may experience structural deformation such as curling or waviness.

The above information disclosed in this Background section is only for enhancement of understanding of the background of the described technology and therefore it may contain information that does not form the prior art that is already known in this country to a person of ordinary skill in the art.

### SUMMARY

The described technology has been made in an effort to provide a mask unit that can improve process accuracy by suppressing structural deformation. More particularly, the described technology relates generally to a mask unit including at least one of the unit masks.

A mask unit according to an exemplary embodiment of the present invention includes: a unit mask having a plurality of patterned areas arranged along a length direction of the unit mask and a dummy area disposed between two of the plurality of patterned areas; a mask frame coupled to lateral ends of the unit mask in the length direction of the unit mask and applying a tension force to the unit mask along the length direction of the unit mask; and a cross-tension member coupled to the dummy area of the unit mask and extending in a direction crossing the length direction of the unit mask to apply a tension force to the unit mask in the direction crossing the length direction of the unit mask.

The cross-tension member may be coupled to a center portion of the unit mask between the lateral ends of the unit mask in the length direction of the unit mask.

Lateral ends of the cross-tension member may be coupled to the mask frame.

A frame coupling groove may be formed in one area of the mask frame coupled with the cross-tension member.

The cross-tension member and the mask frame may be coupled with each other by welding.

The mask frame may include a clamp configured to fix the lateral ends of the unit mask.

In the mask unit, a mask coupling groove may be formed in the dummy area of the unit mask and may be coupled with the cross-tension member.

The cross-tension member and the unit mask may be coupled with each other by welding.

According to the exemplary embodiments of the present invention, accuracy of processes using a mask unit can be improved by suppressing structural deformation of the mask unit.

### BRIEF DESCRIPTION OF THE DRAWINGS

FIG. 1 is a perspective view of a mask unit according to one embodiment of the present invention.

FIG. 2 is a top plan view of the mask unit of FIG. 1.

FIG. 3 is a cross-sectional view of FIG. 2, taken along the line III-III.

### DETAILED DESCRIPTION

The present invention will be described more fully hereinafter with reference to the accompanying drawings, in which exemplary embodiments of the present invention are shown. As those skilled in the art would realize, the described embodiments may be modified in various different ways, all without departing from the spirit or scope of the present invention.

The drawings are schematic and not proportionally scaled. Relative scales and ratios in the drawings may be enlarged or reduced for the purpose of accuracy and convenience, and the scales are arbitrary and are not limited thereto. In addition, like reference numerals designate like structures, elements, or parts throughout the specification. It will be understood that when an element is referred to as being “on” or “above” another element, it can be directly on another element or intervening elements may be present therebetween

Exemplary embodiments described with reference to cross-sectional views represent examples of embodiments in detail. Therefore, various modifications or variations of diagrams are expected and would be apparent to those of ordinary skill in the art. Accordingly, exemplary embodiments are not limited to specific shapes of shown regions, and for example, also include modifications or variations of the shapes which may occur, for example, due to variations during manufacturing.

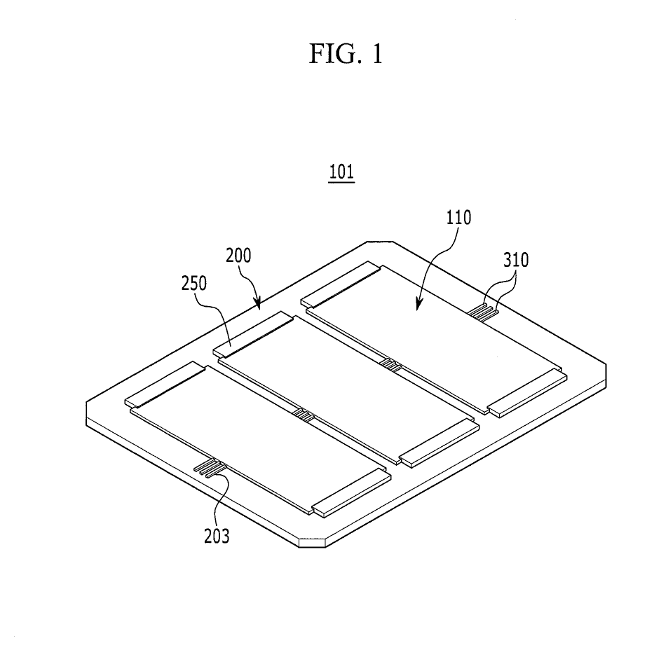

Hereinafter, a mask unit 101 according to a first exemplary embodiment of the present invention will be described with reference to FIG. 1.

As shown in FIG. 1, the mask unit 101 according to the first exemplary embodiment includes at least one of unit masks 110, a mask frame 200, and cross-tension members 310. In addition, the mask frame 200 includes clamps 250 fixing lateral ends of each unit mask 110.

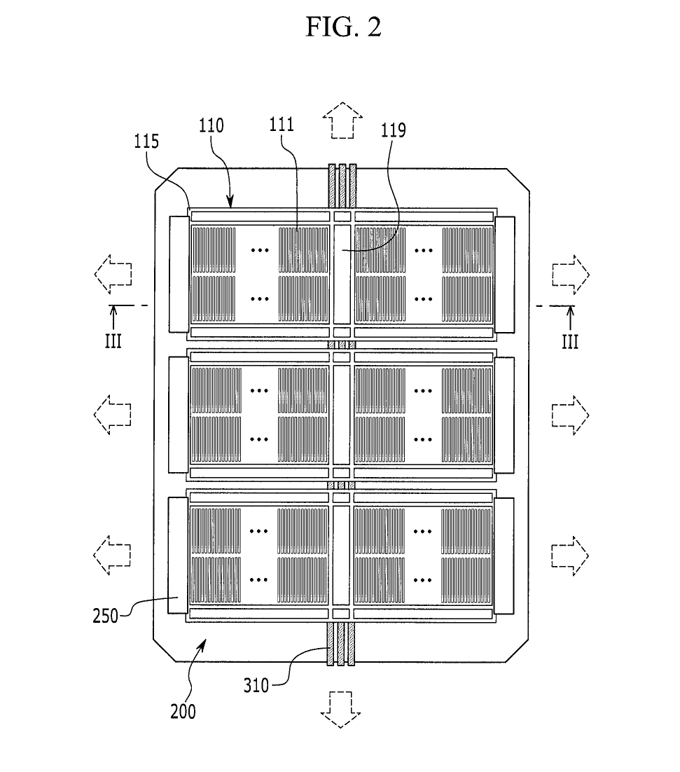

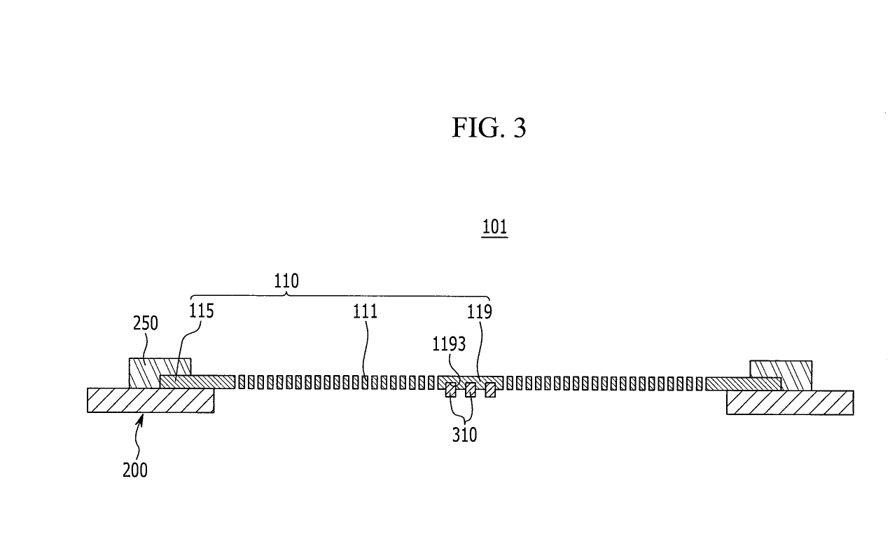

The unit mask 110 is formed as a strip-shaped thin plate. In addition, as shown in FIG. 2, the unit mask 110 includes a plurality of patterned areas 111 arranged in a length direction (e.g., in a direction of the longer side of the mask) and dummy areas 119 respectively disposed between the plurality of patterned areas 111. In each patterned area 111, a fine opening pattern is formed as shown in FIG. 3. A fine opening pattern may be a dot (e.g., a hole) or a slit formed in the thin plate. In each unit mask 110, one or more columns of fine opening patterns may be arranged in the patterned area 111 of each unit mask 110.

In addition, FIG. 2 illustrates that each unit mask 110 includes one dummy area 119 disposed between a pair of patterned areas 111, but the embodiments of the present invention are not limited thereto. That is, each unit mask 110 may include three or more patterned areas 111 and two or more dummy areas 119.

In addition, in one embodiment of the present invention, lateral ends in the length direction of the unit mask 110 become coupling areas 115 coupled with the mask frame 200.

The mask frame 200 fixes lateral ends of the unit mask 110 in its length direction with tension so as to apply a tension force along the length direction of the unit mask 110. Thus, the strength of the mask frame 200 should be strong enough to supply sufficient tension force to the unit mask 110. In this case, the clamps 250 fix lateral ends of the pulled unit mask 110. Accordingly, the unit mask 110 fixed to the mask frame 200 has a tension force along the length direction of the unit mask 110.

The cross-tension member 310 applies a tension force to the unit mask 110 along a direction crossing (e.g., perpendicular to) the length direction of the unit mask 110. The cross-tension member 310 may be formed in the shape of a rib crossing the length direction of the unit mask 110. In addition, the cross-tension member 310 is coupled to the dummy area 119 of the unit mask 110. In further detail, the cross-tension member 310 may be coupled to the dummy area 119 located in a center portion between the lateral ends in the length direction of the unit mask 110. However, embodiments of the present invention are not limited thereto, and the cross-tension member 310 may be coupled to dummy areas 119 other than the dummy area 119 in the center portion. Further, a plurality of cross-tension members 310 may be disposed in the mask unit 101 (e.g., each of the mask units may have a plurality of dummy areas 119 and each of the plurality of cross-tension members 310 may be coupled to corresponding ones of the dummy areas 119).

In addition, as shown in FIG. 3, a mask coupling groove 1193 may be formed in the dummy area 119 of the unit mask 110, coupled with the cross-tension member 310. A part of the cross-tension member 310 is coupled with the mask coupling groove 1193 by being fitted therein. Accordingly, interference due to the cross-tension member 310 can be reduced or minimized. In addition, the cross-tension member 310 may be coupled with the unit mask 110 by welding.

In one embodiment of the present invention, the cross-tension member 310 applies a tension force to the unit mask 110 rather than simply supporting the unit mask 110. That is, the cross-tension member 310 pulls the unit mask 110 in a direction crossing the length direction of the unit mask 110.

Thus, when the unit mask 110 is pulled in the length direction of the unit mask 110, the cross-tension member 310 pulls the unit mask 110 in the direction crossing the length direction of the unit mask 110 to suppress or reduce the occurrence of structural deformation such as curling or waviness.

In this case, the structural deformation due to the tension force applied by the mask frame 200 may mostly occur in a center portion between lateral ends of the unit mask 110. Thus, in one embodiment, when the cross-tension member 310 is coupled to a dummy area 119 disposed in the center portion between the lateral ends in the length direction of the unit mask 110, it is effective for reducing or minimizing structural deformation of the unit mask.

When the structural deformation such as curling or waviness occurs in the unit mask 110, a gap may be formed between the unit mask 110 and a process target substrate or alignment is twisted, thereby causing a failure.

In addition, the lateral ends of the cross-tension member 310 are coupled with the mask frame 200. A frame coupling groove 203 (shown in FIG. 1) may be formed in one area of the mask frame 200 that is coupled with the cross-tension member 310. The frame coupling groove 203 may be formed using the same or substantially similar structural mechanism of a mask coupling groove 1193. Further, the lateral ends of the cross-tension member 310 may be coupled to the mask frame 200 by welding.

Finally, first portions of the frame facing each other at first lateral sides of the mask frame 200 are coupled with lateral ends of the unit mask 110, and frames facing each other at second lateral sides of the mask frame 200 (e.g., substantially perpendicular to the first lateral sides) are coupled with lateral ends of the cross-tension member 310.

With such a configuration, the mask unit 101 according to an embodiment of the present invention can suppress structural deformation so that accuracy of the process using the mask unit 101 can be improved.

That is, the unit mask 110 of the mask unit 101 according to an embodiment of the present invention is fixed to the mask frame 200 so as to have a tension force in the length direction of the unit mask 110, and coupled with the cross-tension member 310 so as to have a tension force in the direction crossing the length direction of the unit mask 110.

Thus, as denoted by the arrows in FIG. 2, the mask unit 101 may have tension force not only in the length direction of the unit mask 101 but also in the direction crossing the length direction.

Thus, sagging of the unit mask 110 can be reduced or prevented by being supported by the tension force, and the unit mask 110 is tensed in a length direction and a crossing direction so that occurrence of structural deformation can be effectively suppressed.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Description of selected symbols

| | |
|---|---|
| 101: mask unit | 110: unit mask |
| 200: mask frame | 250: clamp |
| 310: cross-tension member | |

What is claimed is:

1. A mask unit comprising:
a unit mask having a plurality of patterned areas arranged along a length direction of the unit mask and a dummy area disposed between two of the plurality of patterned areas;
a mask frame coupled to lateral ends of the unit mask in the length direction of the unit mask and applying a tension force to the unit mask along the length direction of the unit mask; and
a cross-tension member coupled to the dummy area of the unit mask and extending in a direction crossing the length direction of the unit mask to apply a tension force to the unit mask in the direction crossing the length direction of the unit mask.

2. The mask unit of claim 1, wherein the cross-tension member is coupled to a center portion of the unit mask between the lateral ends of the unit mask in the length direction of the unit mask.

3. The mask unit of claim 1, wherein lateral ends of the cross-tension member are coupled to the mask frame.

4. The mask unit of claim 3, wherein a frame coupling groove is formed in one area of the mask frame and is coupled with the cross-tension member.

5. The mask unit of claim 3, wherein the cross-tension member and the mask frame are coupled with each other by welding.

6. The mask unit of claim 1, wherein the mask frame comprises a clamp configured to fix the lateral ends of the unit mask.

7. The mask unit of claim 1, wherein a mask coupling groove is formed in the dummy area of the unit mask and is coupled with the cross-tension member.

8. The mask unit of claim 7, wherein the cross-tension member and the unit mask are coupled with each other by welding.
